(19) United States
(12) Patent Application Publication
(10) Pub. No.: US 2010/0007738 A1
(43) Pub. Date: Jan. 14, 2010

(54) METHOD OF ADVANCED PERSON OR OBJECT RECOGNITION AND DETECTION

(75) Inventor: Karl-Heinz Lehnert, Mainz (DE)

Correspondence Address: Oppenheimer Wolff & Donnelly LLP, Plaza VII, Suite 3300, 45 South Seventh Street, Minneapolis, MN, 55402-1609, US

(73) Assignee: International Business Machines Corporation, Armonk, NY (US)

(21) Appl. No.: 12/170,952

(22) Filed: Jul. 10, 2008

(51) Int. Cl. H04N 7/18

(52) U.S. Cl. 348/159; 348/E07.085

(57) ABSTRACT

A method for advanced recognition and detection of persons and objects comprises providing an intelligent video recognition system including a plurality of video cameras having advanced recognition methods associated therewith, providing a location awareness system with active emitting tags and including one or more receiver antennas, detecting outlier persons or objects by processing intermediate data output from the intelligent video recognition system and location awareness system with output from a master database to generate relevant and focused alert data through comparing spatial information, classifying the alert data as alerts or allowed events based on business logic described in a rule engine, displaying the alert data along with primary video stream and active emitting tag data in real-time in a user visualization engine, and allowing the relevant and focused alert data to be replayed and displayed in the user visualization engine at a future time.

### FIELD OF THE INVENTION

The present invention generally relates to a monitoring system operating on a computer system. The present invention more specifically relates to the detection and recognition of persons or objects using a computer system.

### BACKGROUND OF THE INVENTION

Individuals tasked with securing sensitive or restricted areas against prohibited access by persons or objects often rely on video surveillance systems. Such video surveillance systems are often error-prone and require constant alertness from the individual. Although installations may use physical fences or gates to secure locations, other constraints may render such physical security impracticable.

One existing method to provide alert data on persons and objects is to use a location awareness system (LAS) with active emitting tags. Such active emitting tags provide location awareness data using transmission technologies such as radio frequency id (RFID), ultra wide band wireless (UWB), or wireless local area network (WLAN). LAS deployments often use one or more antennas to receive location awareness data. Location awareness data can be visualized using visualization engines which parse and display locations received from active emitting tags. LAS deployments can detect whether persons or objects access sensitive or restricted areas. LAS deployments typically represent known persons or objects which have associated tags. However, LAS deployments are underinclusive because they cannot provide location information for any persons or objects without tags.

Another existing method to provide data on persons and objects is to use an intelligent video recognition system. In this type of system, one or more video cameras may provide an unstructured video stream. Intelligent video recognition systems analyze the unstructured video stream to generate metadata describing objects in the stream. Exemplary metadata include object detection and classification, location, movement and velocity data. The metadata can be visualized by overlay on the video screen, or via informational messages shown to the administrator. Although intelligent video recognition systems can provide functionality for facial capture and recognition, such functionality is computationally difficult and time-intensive to generate. Furthermore, intelligent video recognition systems are overinclusive because they generate false positive alerts on approved persons or objects.

What is needed is a system and method to provide focused and relevant alert notifications on persons or objects, without overlooking persons or objects which lack active emitting tags, and without incorrectly warning about persons or objects which are approved to be in the location of interest at the time of interest.

### BRIEF SUMMARY OF THE INVENTION

One aspect of the present invention includes a method for advanced recognition and detection of persons or objects. Particularly, the present invention may provide the capability to receive relevant and focused alert data around potential restricted access.

In one embodiment, the present invention merges output from an intelligent video recognition system with output from a location awareness system with active emitting tags to detect outlier persons or objects. The present invention may filter and process intermediate data output from the intelligent video recognition system and location awareness system against output from a master database to generate relevant and focused alert data by comparing positional coordinates, velocity and movement or other available information. The present invention may classify the relevant and focused alert data as alerts or allowed events based on business logic described in a rule engine and display the resulting alert data along with optional primary video stream and active emitting tag data in a user visualization engine. The present invention may further store the relevant and focused alert data in an optional archive database to support post-event investigation.

### BRIEF DESCRIPTION OF THE DRAWINGS

FIG. 1 is a diagram illustrating a sample Area that may be monitored by the system and method of the present invention.

FIG. 2 is a diagram generally illustrating the monitoring system and method in accordance with the present invention operating on a computer system.

FIG. 3 is a diagram illustrating the types of data that may be detected, processed and stored as intermediate data.

FIG. 4 is a diagram illustrating the details of one exemplary master data set containing a set of LAS data.

FIG. 5 is a diagram illustrating the details of one exemplary rule engine containing a set of business logic describing access protocols for persons and objects with and without tags.

FIG. 6 is a diagram illustrating output alert data displayed on a user visualization system.

FIG. 7 is a flowchart illustrating a process that may be used to provide alert data on persons and objects in accordance with one exemplary embodiment of the present invention.

### DETAILED DESCRIPTION OF THE INVENTION

One aspect of the present invention includes a method to generate and evaluate alert data about moving objects and persons using a dedicated data evaluation and matching method. The method in accordance with the present invention may allow an administrator to maintain spatial integrity around a location by flagging objects or people moving in violation of access protocols. In one exemplary embodiment, the inventive method may generate relevant and focused alert data by combining filtered intermediate data with master data sets and a rule engine.

Filtered intermediate data may be generated from alert data output from an LAS deployment and notification data output from an intelligent video recognition system. In one embodiment, a system may generate filtered intermediate data by comparing the spatial data output from the LAS deployment at a specified time with the spatial data output from the intelligent video recognition system at the specified time. The spatial data may include, for example, a person's or object's position, speed, and direction of movement (i.e., the velocity vector).

A master data set may describe tuples of expected or allowed conditions for active emitting tags in an LAS deployment, along with rules to classify which tuples should generate alert events. In one embodiment, such tuples may be stored in a relational database. Exemplary data stored in a master data set might include an active emitting tag id, a person id, the person's work shift schedule, the person's login and logout schedules, the person's access rules, and area classifications.

A rule engine may classify the filtered intermediate data as alert data or allowed access by applying business logic and the master data set. As will be appreciated by those skilled in the art, business logic may describe rules specific to the organization or location being protected by the present invention.

In accordance with the present invention, an optional archive database may store a history of events and alerts. Exemplary data stored in an archive database might include alerts and event sensor readings or videos and observations. As will be appreciated by those skilled in the art, such data may be used for post-event investigations such as breaches of a perimeter or violations of access rules. In one embodiment, the archive database may be augmented to store the focused and relevant alert data generated by the present invention.

In accordance with the present invention, a user visualization engine may display the focused and relevant alert data to the administrator monitoring the system. For example, the user visualization engine may overlay the alert data on a real-time display of intelligent video recognition data and LAS data. The user visualization engine may also support playback display of the relevant data to enable the administrator to review or replay the data at a later time, such as in conjunction with an investigation of a breach of security.

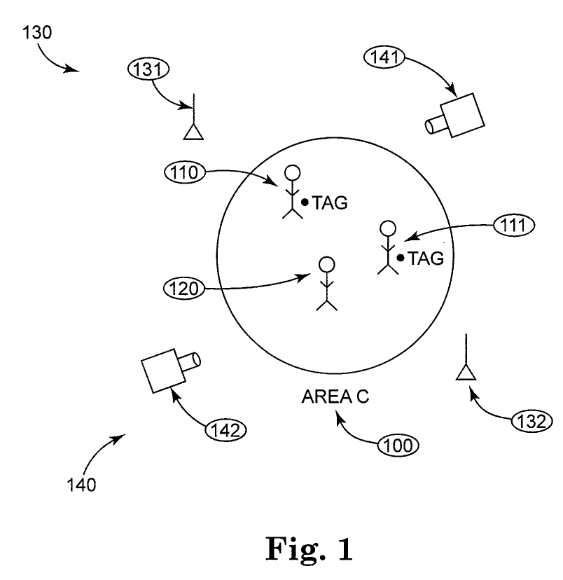

One exemplary embodiment of the present invention is depicted in FIG. 1. In particular, FIG. 1 illustrates a sample Area C 100 that may be monitored in accordance with the present invention. As illustrated in FIG. 1, first and second persons 110 and 111 have active emitting tags as badges b₁ and b₂, respectively. As further illustrated in FIG. 1, a third person 120 lacks an active emitting tag. As will be discussed in further detail to follow, an installed LAS system 130 comprising one or more antennas 131, 132 may be structured to detect the two active emitting tags b₁ and b₂ on first and second persons 110 and 111, respectively. Furthermore, an installed intelligent video recognition system 140 comprising one or more video cameras 141, 142 may be structured to detect the first, second and third persons 110, 111 and 120 in the Area C.

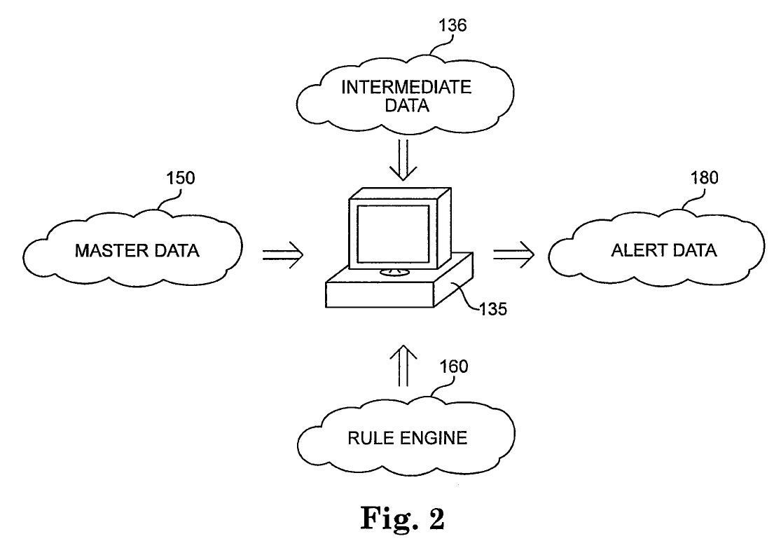

FIG. 2 is a diagram generally illustrating the monitoring system and method in accordance with the present invention operating on a computer system 135. As illustrated in FIG. 2, the computer system 135 receives intermediate data 136, master data 150, and applies rule engine data 160. In particular, computer system 135 may process and compare intermediate data 136 against master data 150 and rule engine data 160 in order to create and output alert data 180. Intermediate data 136 may include, among other data, the data output from the installed LAS system 130 and the data from the installed intelligent video recognition system 140.

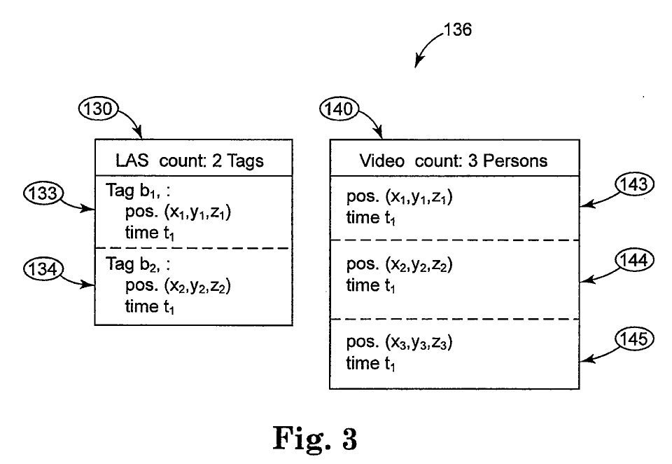

FIG. 3 is a diagram illustrating the types of data that are detected, processed and stored as intermediate data 136. With reference to the monitored Area C in FIG. 1, the LAS system 130 may utilize the one or more antennas 131, 132 to detect the two active emitting tags b₁ and b₂ on first and second persons 110 and 111, respectively. For example, the LAS system 130 may detect tag b₁ at position (x₁, y₁, z₁) at time t₁. This information may then be stored as LAS data as indicated by entry 133 in FIG. 3. Similarly, the LAS system may detect tag b₂ at position (x₂, y₂, z₂) at time t₁. This information may then be stored as LAS data as indicated by entry 134 in FIG. 3. The present invention may also use additional LAS data not shown, such as persons' or objects' speed or direction.

With reference again to the monitored Area C in FIG. 1, the intelligent video recognition system 140 may utilize the one or more video cameras 141, 142 to detect the first, second and third persons 110, 111 and 120 in the Area C. For example, the intelligent video recognition system 140 may detect first person 110 at position (x₁, y₁, z₁) at time t₁, second person 111 at position (x₂, y₂, z₂) at time t₁, and third person 120 at position (x₃, y₃, z₃) at time t₁. The position of first person 110 may then be stored as entry 143, the position of second person 111 may be stored as entry 144, and finally, the position of third person 120 may be stored as entry 145. The present invention may also use additional intelligent video recognition data not shown, such as persons' or objects' speed or direction.

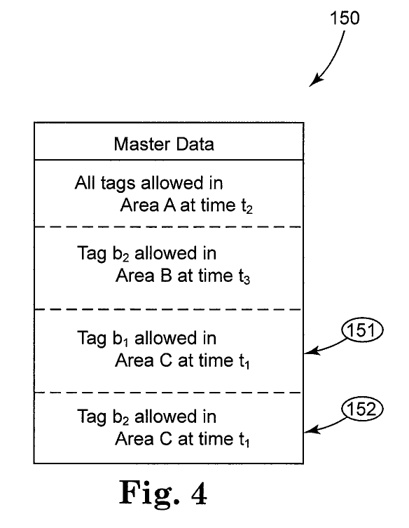

FIG. 4 is a diagram illustrating the details of one exemplary master data set 150 containing a set of LAS data. As shown in FIG. 4, the master data set 150 may include, for example, an entry 151 indicating that tag b₁ is allowed in Area C at time t₁, and an entry 152 indicating that tag b₂ is also allowed in Area C at time t₁.

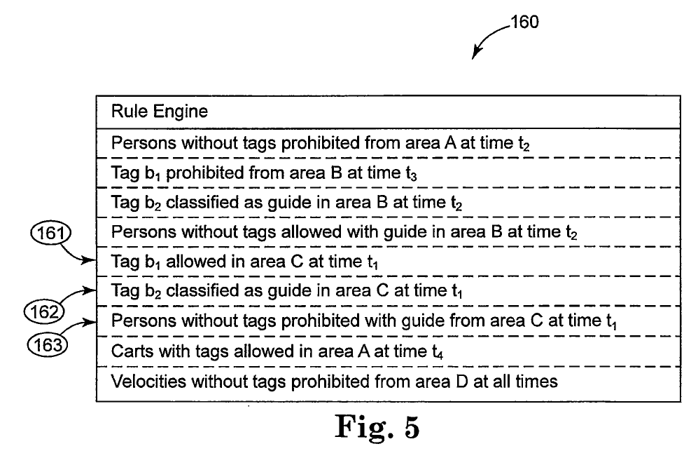

FIG. 5 is a diagram illustrating the details of one exemplary rule engine 160 containing a set of business logic describing access protocols for persons and objects with and without tags. As shown in FIG. 5, the rule engine 160 may include, for example, an entry 161 indicating that that tag b₁ is allowed in Area C at time t₁, an entry 162 indicating that tag b₂ is classified as a Guide in Area C at time t₁, and an entry 163 indicating that persons without tags are prohibited from Area C at time t₁.

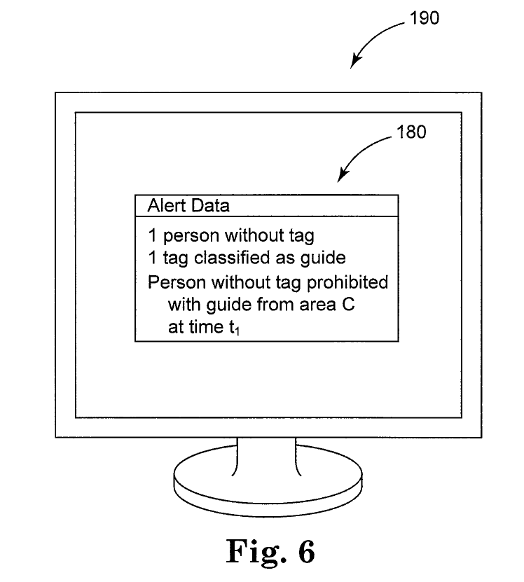

With reference to FIGS. 1-5 previously described, those skilled in the art will now appreciate that the system and method in accordance with the present invention may accept as intermediate data 136 the output from the LAS system 130 and from the intelligent video recognition system 140 to detect that the third person 120 is in Area C 100 without a tag. For each person with a tag found in Area C (i.e., first and second persons 110, 111), the present invention may use the master data system 150 to determine whether their access is allowed based upon the entries 151, 152 in the master data set. The present invention may then check the rule engine 160 to find that tag b₁ is allowed according to entry 161, and that tag b₂ is classified as a Guide in Area C at time t₁ according to entry 162, but that persons without tags are prohibited from Area C at time t₁ according to entry 163. The present invention may then output relevant and focused alert data 180 describing the prohibited access, which may be displayed on a user visualization system 190 as illustrated in FIG. 6. Particularly, the user visualization system 190 may display the relevant and focused alert data, either in real-time or later via playback.

Those skilled in the art will appreciate that the previous discussion in reference to FIGS. 1-5 merely illustrates one exemplary embodiment of the present invention. Thus, for example, the intermediate data 136, master data 150, rule engine 160, and alert data 180 may comprise numerous other types of information, rules and entries without departing from the intended scope of the present invention.

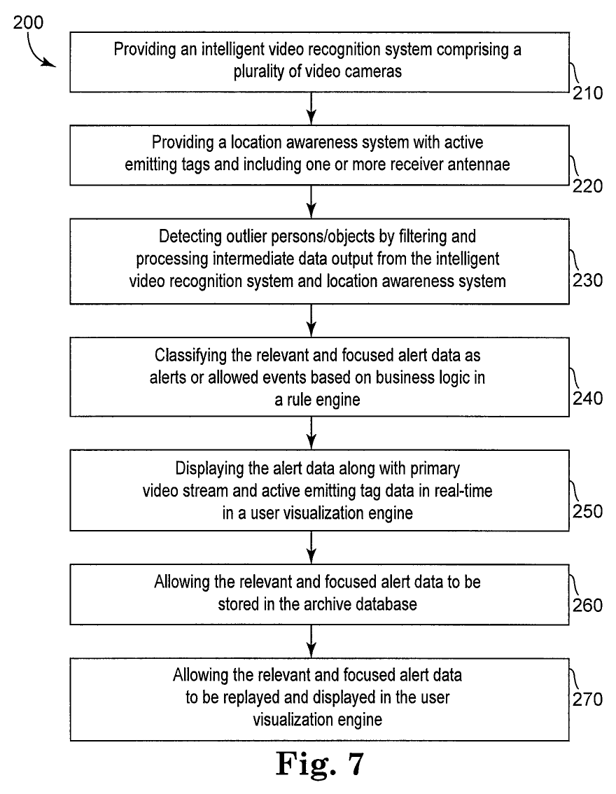

FIG. 7 is a flowchart illustrating one exemplary process 200 for advanced recognition and detection of persons and objects in accordance with the present invention. In particular, the process 200 begins at step 210 by providing an intelligent video recognition system including a plurality of video cameras having advanced recognition methods associated therewith. In one exemplary embodiment, the advanced recognition methods may include facial capture and recognition, although numerous other types of advanced recognition methods are also available. The process continues at step 220 by providing a location awareness system with active emitting tags and including one or more receiver antennas. In one exemplary embodiment, the active emitting tags comprise radio frequency identification tags. However, numerous other types of active emitting tags are contemplated as will be appreciated by those skilled in the art such as ultra wide band wireless (UWB), or wireless local area network (WLAN). Next, in step 230, outlier persons or objects are detected by filtering and processing intermediate data output from the intelligent video recognition system and location awareness system with output from a master database to generate relevant and focused alert data through comparing positional coordinates, velocity and movement information. Then, in step 240, the relevant and focused alert data are classified as alerts or allowed events based on business logic described in a rule engine. Next, in step 250, the alert data along with primary video stream and active emitting tag data are displayed in real-time in a user visualization engine. Then, in step 260, the alert data along with primary video stream and active emitting tag data may be stored for review in an archive database. Finally, the process ends at step 270 by allowing the relevant and focused alert data to be replayed and displayed in the user visualization engine at a future time.

As will be appreciated by those skilled in the art, process 200 is only one exemplary embodiment of a process for advanced recognition and detection of persons and objects in accordance with the present invention. As will be further appreciated by those skilled in the art, the order and number of steps in the flowchart of FIG. 7 may be modified without departing from the intended scope of the present invention.

Although the present invention has been described with reference to preferred embodiments, workers skilled in the art will recognize that changes may be made in form and detail without departing from the spirit and scope of the invention.

1. A method for advanced recognition and detection of persons and objects, comprising:
providing an intelligent video recognition system including a plurality of video cameras having advanced recognition methods associated therewith, wherein the advanced recognition methods include facial capture and recognition;
providing a location awareness system with active emitting tags and including one or more receiver antennas, wherein the active emitting tags comprise radio frequency identification tags;
detecting outlier persons or objects by filtering and processing intermediate data output from the intelligent video recognition system and location awareness system with output from a master database to generate relevant and focused alert data through comparing positional coordinates, velocity and movement information;
classifying the relevant and focused alert data as alerts or allowed events based on business logic described in a rule engine;
displaying the relevant and focused alert data along with primary video stream and active emitting tag data in real-time in a user visualization engine;
storing the relevant and focused alert data along with primary video stream and active emitting tag data in an archive database; and
allowing the relevant and focused alert data to be replayed and displayed in the user visualization engine at a future time.

2. The method of claim 1, wherein event sensor readings are also stored in the archive database.

3. The method of claim 1, wherein observations regarding the relevant and focused alert data and the primary video stream are also stored in the archive database.

4. The method of claim 1, wherein the user visualization engine overlays the relevant and focused alert data on the primary video stream and the active emitting tag data in real-time.

5. The method of claim 1, wherein the step of displaying the relevant and focused alert data further comprises describing prohibited access of persons or objects.

6. The method of claim 5, wherein the description of prohibited access is displayed on a display of the user visualization engine.

7. A method for advanced recognition and detection of persons and objects, comprising:
providing an intelligent video recognition system including a plurality of video cameras having advanced recognition methods associated therewith, wherein the advanced recognition methods include facial capture and recognition;
providing a location awareness system with active emitting tags and including one or more receiver antennas;
detecting outlier persons or objects by filtering and processing intermediate data output from the intelligent video recognition system and location awareness system with output from a master database to generate relevant and focused alert data through comparing positional coordinates, velocity and movement information, wherein the master database describes tuples of expected or allowed conditions for the active emitting tags, along with rules to classify which tuples should generate alert events;
classifying the relevant and focused alert data as alerts or allowed events based on business logic described in a rule engine;
displaying the relevant and focused alert data along with primary video stream and active emitting tag data in real-time in a user visualization engine;
storing the relevant and focused alert data along with primary video stream and active emitting tag data in an archive database; and
allowing the relevant and focused alert data to be replayed and displayed in the user visualization engine at a future time.

8. The method of claim 7, wherein the active emitting tags comprise radio frequency identification tags.

9. The method of claim 7, wherein the active emitting tags comprise ultra wide band wireless identification tags.

10. The method of claim 7, wherein the active emitting tags comprise wireless local area network identification tags.

11. The method of claim 7, wherein the master database contains data including an active emitting tag id.

12. The method of claim 7, wherein the master database contains data including access rules of persons or objects.

13. The method of claim 7, wherein the master database contains data including area classifications of persons or objects.

14. The method of claim 7, wherein the master database contains data including a work shift schedule of a person.

15. The method of claim 7, wherein business logic described in the rule engine contains access protocols for persons and objects with and without active emitting tags.

16. A method for advanced recognition and detection of persons and objects, comprising:
providing an intelligent video recognition system including a plurality of video cameras having advanced recognition methods associated therewith, wherein the advanced recognition methods include facial capture and recognition;
providing a location awareness system with active emitting tags and including one or more receiver antennas;
detecting outlier persons or objects by filtering and processing intermediate data output from the intelligent video recognition system and location awareness system with master data output from a master database to generate relevant and focused alert data through comparing positional coordinates, velocity and movement information;
classifying the relevant and focused alert data as alerts or allowed events based on business logic described in a rule engine and the master data output from the master database, wherein the business logic describes rules specific to a location being protected by the intelligent video recognition system and the location awareness system;
overlaying the relevant and focused alert data on a real-time display of primary video stream and active emitting tag data, wherein the real-time display of primary video stream and active emitting tag data is performed with a user visualization engine;
storing the relevant and focused alert data along with primary video stream and active emitting tag data in an archive database; and
allowing the relevant and focused alert data to be replayed and displayed in the user visualization engine at a future time.

17. The method of claim 16, wherein the active emitting tags comprise radio frequency identification tags.

18. The method of claim 16, wherein the step of overlaying the relevant and focused alert data on a real-time display of primary video stream and active emitting tag data further comprises describing prohibited access of persons or objects.

19. The method of claim 18, wherein the description of prohibited access is displayed on the user visualization engine.

20. The method of claim 16, wherein the master database contains data including an active emitting tag id.
